(19) United States
(12) Patent Application Publication
(10) Pub. No.: US 2023/0284625 A1
(43) Pub. Date: Sep. 14, 2023

(54) METHOD FOR CULTIVATING CITRUS PLANT

(71) Applicant: Denka Company Limited, Tokyo (JP)

(72) Inventors: Kazuma HONDA, Tokyo (JP); Minoru MORIOKA, Tokyo (JP); Gavin DIAZ, New York, NY (US)

(73) Assignee: Denka Company Limited, Tokyo (JP)

(21) Appl. No.: 17/694,056

(22) Filed: Mar. 14, 2022

(51) Int. Cl. A01N 59/16; A01N 25/02

(52) U.S. Cl. CPC A01N 59/16; A01N 25/02

(57) ABSTRACT

Disclosed is a method for cultivating a citrus plant, comprising: applying to the citrus plant a liquid composition comprising Fe ions, wherein at least a portion of the Fe ions are Fe²⁺ ions, wherein the citrus plant is cultivated in sandy soil.

### TECHNICAL FIELD

The present invention relates to a method for cultivating a citrus plant.

### BACKGROUND

Citrus greening disease (also called huanglongbing or HLB) is one of the diseases of citrus plants. HLB is a plant disease caused by infection of citrus plants by a pathogen such as Candidatus liberibacterb. The pathogen is mediated by Diaphorina citri. Citrus plants infected with HLB pathogens exhibit the following symptoms: a portion of the leaves turns yellow; the ripe fruits are small in size; the majority of the surface of the ripe fruits remains green; and the ripe fruits are bitter in taste. As the HLB progresses, citrus plants gradually get weak and wither from the tips of the branches and eventually die.

U.S. Pat. No. 8,945,631 discloses a method of treating HLB in a citrus plant comprising applying a liquid comprising Fe²⁺ ions to leaves, rhizosphere, or both, of a citrus plant infected with a pathogen of HLB.

### SUMMARY

U.S. Pat. No. 8,945,631 only verifies the therapeutic effect against HLB under conditions where citrus plants are grown in soil for raising vegetable seedlings. Furthermore, the liquid comprising Fe²⁺ ions are applied to citrus seedlings as frequently as once in 5 days.

An object of the present invention is to provide a cultivation method capable of alleviating the symptoms of HLB of citrus plant even the citrus plant is cultivated under a natural environment.

A method for cultivating a citrus plant according to an aspect of the present invention, comprises applying to the citrus plant a liquid composition comprising Fe ions, wherein at least a portion of the Fe ions are Fe²⁺ ions wherein the citrus plant is cultivated in sandy soil.

### DETAILED DESCRIPTION

Embodiments of the present invention will now be described in detail.

A method for cultivating a citrus plant according to an embodiment is a method comprising applying to the citrus plant a liquid composition comprising Fe ions, wherein at least a portion of the Fe ions are Fe²⁺ ions wherein the citrus plant is cultivated in sandy soil.

The citrus plant includes, for example, Mandarin oranges, oranges, lemons, shaddocks, yuzus and kumquats. The citrus plant includes, for example, orange (Citrus sinensis), grapefruit (Citrus paradisi) and lemon (Citrus limon). The orange may be a fast-growing species such as Hamlin orange or a late-growing species such as Valencia orange.

The method for cultivating a citrus plant according to the present embodiment may be directed to a citrus plant infected with an HLB pathogen. In such a case, the method according to the present embodiment alleviates the HLB symptoms of the citrus plant. Alternatively, the method according to the present embodiment may be directed to a citrus plant that is not infected with an HLB pathogen. Even the citrus plant becomes being infected with an HLB pathogen after applying the method according to the present embodiment, the symptoms of HLB of the citrus plant are alleviated.

The citrus plant is cultivated in sandy soil. The sandy soil is a general term for soil comprising 50% or more of coarse particles, and includes sandy soil having a particle diameter of 2.0 mm or less and gravel soil having a particle diameter of more than 2.0 mm.

The citrus plant may be cultivated in an environment where Diaphorina citri inhabits. When the citrus plant is cultivated in a natural environment where Diaphorina citri inhabits, an HLB pathogen is mediated by Diaphorina citri. For this reason, the citrus plant is in an environment where it is easily infected by an HLB pathogen. Even in such an environment, the citrus plant cultivated by the method according to the present embodiment is not infected with the HLB pathogen, or even infected with the HLB pathogen, the symptoms of HLB of the citrus plant are alleviated.

The method for cultivating a citrus plant according to the present embodiment may be directed to a citrus plant infected with a pathogen of brown rot disease. Brown rot disease is a disease caused by the infection of citrus plants by a pathogen such as Phytophthora, resulting in fruit drop. The citrus plant to which the method according to the present embodiment is applied maintains the quality of fruit even if it is infected with a pathogen of brown rot disease.

The liquid composition applied to the citrus plant comprises Fe ions, wherein at least a portion of the Fe ions are Fe²⁺ ions. Such a liquid composition can be obtained, for example, by dissolving an iron compound capable of providing Fe²⁺ ions in water. The iron compound capable of providing Fe²⁺ ions is not particularly limited as long as it can release Fe²⁺ ions in an aqueous solution. As the iron compound, for example, a divalent iron compound such as FeO or FeSO₄ may be used. In addition, an iron compound containing a trivalent iron in a solid state, such as iron citrate, can be an iron compound capable of providing Fe²⁺ ions as long as it can release Fe²⁺ ions in an aqueous solution. In addition, the liquid composition may be a combination of a trivalent iron compound such as Fe₂O₃ or FeCl₃ with a reducing agent to provide Fe²⁺ ions by the effect of the reducing agent to reduce Fe³⁺ ions to Fe²⁺ ions.

The concentration of the total Fe ions in the liquid composition is preferably 100 mg/L to 1000 mg/L, more preferably 100 mg/L to 500 mg/L, and still more preferably 100 mg/L to 300 mg/L. The total Fe ions at the concentration of the above lower limit or higher easily exert the effect of alleviating HLB symptoms. The total Fe ions at the concentration of the above upper limit or lower can avoid the damage to the citrus plant.

The “total Fe ions” mean all Fe ions, including Fe²⁺ ions and Fe³⁺ ions. The concentration of Fe ions in the liquid composition can be measured by an established method using o-phenanthroline. O-phenanthroline selectively forms a complex with Fe²⁺ ions. Therefore, Fe²⁺ ions can be selectively quantified by measuring the absorbance of the complex. The total Fe ion concentration in the liquid composition can be determined by reducing Fe³⁺ ions in the liquid composition to convert all Fe ions into Fe²⁺ ions and then using the o-phenanthroline method.

Preferably, at least 18% by weight of the total Fe ions of the liquid composition are Fe²⁺ ions. When at least 18% by mass of the total Fe ions are Fe²⁺ ions, the effect of alleviating HLB symptoms is easily exerted. All (100% by weight) of the total Fe ions of the liquid composition may be Fe²⁺ ions.

The liquid composition may comprise, in addition to Fe ions, metal ions such as Ca ions, Mg ions, Al ions, Ba ions, Cr ions, K ions, Mn ions, and Na ions. The liquid composition may comprise an acid in order to stably retain Fe²⁺ ions and to maintain the effect of alleviating HLB symptoms. Such an acid includes citric acid, malic acid, tartaric acid, oxalic acid, ascorbic acid, and the like. Among them, citric acid is preferable as the acid. From the viewpoint of stably retaining Fe²⁺ ions, the concentration of the acid is preferably 100 mg/L to 10 g/L, and more preferably 500 mg/L to 2 g/L.

The means of applying the liquid composition to the citrus plant is not particularly limited. Examples of such means include means for spraying the liquid composition onto leaves of the citrus plant and means for irrigating rhizosphere of the citrus plant with the liquid composition. The liquid composition is preferably applied to rhizosphere of the citrus plant. When the liquid composition is applied to rhizosphere, it is expected that the acid released from roots of the citrus plant reduces Fe³⁺ ions to Fe²⁺ ions, thereby maintaining the effect of alleviating HLB symptoms. From the viewpoint of convenience of application, the liquid composition is preferably irrigated using an irrigation tube.

The application frequency of the liquid composition may be 2 to 8 times per a year. Alternatively, the application frequency of the liquid composition may be once in 45 days to 180 days. The application amount of the liquid composition may be 0.1 g to 3.0 g of Fe²⁺ ions, preferably 0.27 g to 1.1 g of Fe²⁺ ions per a citrus plant in a year. The application frequency and the application amount within the above ranges easily exert the effect of alleviating HLB symptoms.

Other preferred embodiments of the present invention are as follows.
[1] A liquid composition for cultivation of a citrus plant cultivated in sandy soil, comprising Fe ions wherein at least a portion of the Fe ions are Fe²⁺ ions.
[2] The liquid composition of [1], wherein the concentration of total Fe ions in the liquid composition is from 100 mg/L to 1000 mg/L.
[3] The liquid composition of [1] or [2], wherein at least 18% by weight of the total Fe ions of the liquid composition is Fe²⁺ ions.
[4] The liquid composition of any one of [1] to [3], wherein the citrus plant is Citrus sinensis, Citrus paradisi or Citrus limon.
[5] The liquid composition of any one of [1] to [4], for a citrus plant infected with a pathogen of citrus greening disease.
[6] The liquid composition of any one of [1] to [5], for citrus plants cultivated in an environment where Diaphorina citri inhabits.
[7] The liquid composition of any one of [1] to [6], for citrus plants infected with a pathogen of brown rot disease.

### Examples

Preparation of a Liquid Composition Comprising Fe²⁺ ions

A liquid composition was prepared by diluting TetsuRiki Aqua (registered trademark in Japan) F10 (AICHI STEEL CORPORATION) 100 times with water. The total Fe ion and Fe²⁺ ion concentrations of the liquid composition were 150 mg/L and 27 mg/L, respectively. That is, 18% by weight of the total Fe ions were Fe²⁺ ions. Organic acid in the liquid composition was measured, and the citric acid concentration was 1.09 g/L.

Citrus Plant Cultivation

Valencia orange and Hamlin orange were cultivated in sandy soil in Florida. In the Fe²⁺ ion-applied plot, 5 L of the above liquid composition was applied once in 45 days per one citrus plant (hereinafter referred to as “tree”) using an irrigation tube. In the untreated plot, 5 L of water was applied once in 45 days per one tree using an irrigation tube. The application started in June 2019 and the trees were evaluated at each time point in June 2019, January 2020 June 2020 and January 2021. Almost all trees were infected with HLB pathogen, and were cultivated in an environment where Diaphorina citri inhabits.

Evaluation Items

Evaluation items are root density, soil nutrients, soil pH, fruit yield, leaf component analysis, pathogen quantification, crown volume and crown density.

Results

1) Root Density

| Root density (mg/L soil) | | | | | |
|---|---|---|---|---|---|
| June | January | June | Change (%) | | |
| 2019 | 2020 | ]2020 | 0-6 mo. | 6-12 mo. | 0-12 mo. |

Valencia

| | | | | | | |
|---|---|---|---|---|---|---|
| Fe²⁺ | 386.11 | 554.44 | 634.49 | 43.60 | 14.44 | 64.33 |
| plot | | | | | | |
| Untreated | 816.85 | 741.75 | 733.03 | −9.19 | −1.18 | −10.26 |
| plot | | | | | | |

Hamlin

| | | | | | | |
|---|---|---|---|---|---|---|
| Fe²⁺ | 537.77 | 1119.52 | 1192.50 | 108.18 | 6.52 | 121.75 |
| plot | | | | | | |
| Untreated | 817.88 | 1119.81 | 1258.07 | 36.92 | 12.35 | 53.82 |
| plot | | | | | | |

The table above shows the root density from June 2019 to June 2020 and the % change in root density for a half year or one year. Both in the first half of the year (from summer to winter) and in the next half of the year (from winter to summer), the root density of Valencia orange in the Fe²⁺ ions-applied plot increased. On the other hand, in the same periods, the root density of Valencia orange in the untreated plot decreased. The root density of Hamlin orange increased through a year in both plots. However, the root density increased more remarkably in the Fe²⁺ ions-applied plots than in the untreated plot. Fe²⁺ ions were effective in increasing root density in both varieties of the trees. The increase in root density was remarkable in the first half year from the start of the application. In trees infected with HLB pathogen, the root system invisible from the above-ground part is most greatly damaged by the pathogen. Therefore, it is considered that Fe²⁺ ions having an effect of increasing the root density greatly contribute to alleviation of HLB symptoms.

% change from June 2020 to January 2021

| | Valencia | Hamlin |
|---|---|---|
| Fe²⁺ plot | 78.29 | 0.40 |
| Untreated plot | 31.56 | 17.50 |

The table above shows the % change in root density from June 2020 to January 2021. No significant difference was observed in root density in any of the plots.

2) Soil Nutrients

Soil Nutrients in June 2020 (ppm)

| Valencia | P | K | Mg | Ca | S | B |
|---|---|---|---|---|---|---|
| Fe²⁺ plot | 130.70 | 112.50 | 158.50 | 1919.00 | 17.60 | 0.99 |
| Untreated plot | 150.50 | 120.30 | 155.30 | 2208.20 | 33.90 | 0.96 |
| | Zn | Mn | Fe | Cu | CEC | |
| Fe²⁺ plot | 54.14 | 13.30 | 12.90 | 22.48 | 6.05 | |
| Untreated plot | 72.99 | 14.80 | 14.90 | 19.18 | 6.80 | |
| Hamlin | P | K | Mg | Ca | S | B |
| Fe²⁺ plot | 141.10 | 145.30 | 78.90 | 1505.50 | 62.00 | 0.91 |
| Untreated plot | 130.10 | 141.80 | 87.60 | 1446.90 | 53.50 | 0.96 |
| | Zn | Mn | Fe | Cu | CEC | |
| Fe²⁺ plot | 72.91 | 13.20 | 22.50 | 42.44 | 5.77 | |
| Untreated plot | 79.23 | 14.80 | 19.10 | 39.40 | 5.60 | |

CEC is short for Cation Exchange Capacity.

The table above shows the amount of soil nutrients in June 2020. In Valencia orange, the soil in the Fe²⁺ ions-applied plot contained less P, S, and Zn than that in the untreated plot. This suggests that Valencia orange treated with Fe²⁺ ions absorbed more of these nutrients. In the case of Hamlin orange, no remarkable difference was observed between the soil in the Fe²⁺ ions-applied plot and that in the untreated plot. The trees treated with Fe²⁺ ions may utilize more S to alleviate HLB and other stresses.

% Change in soil nutrients from June 2020 to January 2021

| Valencia | P | K | Mg | Ca | S | B |
|---|---|---|---|---|---|---|
| Fe²⁺ plot | 39.28 | −30.28 | 21.57 | 39,78 | −27.59 | 8.42 |
| Untreated plot | 21.74 | −37.10 | 5.78 | 11.79 | −40.31 | −3.03 |
| | Zn | Mn | Fe | Cu | CEC | |
| Fe²⁺ plot | 84.82 | 64.34 | 35.38 | −1.89 | 29.64 | |
| Untreated plot | 47.81 | 44.81 | 28.57 | 8.48 | 7.13 | |
| Hamlin | P | K | Mg | Ca | S | B |
| Fe²⁺ plot | 6.02 | −38.47 | 24.21 | 16.59 | −77.90 | −18.68 |
| Untreated plot | −3.23 | −48.87 | 5.94 | −1.56 | −64.49 | −29.17 |
| | Zn | Mr | Fe | Cu | CEC | |
| Fe²⁺ plot | 46.87 | 67.42 | 15.56 | 11.29 | 6.41 | |
| Untreated plot | 22.19 | 37.16 | 39.27 | 6.83 | −1.96 | |

The table above shows the 0% change in soil nutrients from June 2020 to January 2021. No significant difference was observed in the % change of soil nutrients between the soils in the Fe²¹ ions-applied plot and that in the untreated plot in Valencian orange. Significant differences were observed in the % change of Ca and CEC between the soils in the Fe²⁺ ions-applied plot and that in the untreated plot in Hamlin orange.

3) Soil pH

Soil pH

| | Day 2 | Day 10 | Day 20 | Day 30 |
|---|---|---|---|---|
| Valencia | | | | |
| Fe²⁺ plot | 6.98 | 6.75 | 6.69 | 6.27 |
| Untreated plot | 6.87 | 6.53 | 6.58 | 6.34 |
| Hamlin | | | | |
| Fe²⁺ plot | 6.92 | 6.70 | 6.09 | 6.10 |
| Untreated plot | 6.75 | 6.80 | 6.12 | 6.27 |

The table above shows the soil pH from Day 2 to Day 30 after the start of Fe²⁺ ions application. In any of the plots, the pH of the soil on day 30 was in the optimum range (5.8 to 6.5). In addition, since the pH of the soil in the Fe²⁺ ions-applied plot was lower than that in the untreated plot, Fe²⁺ ions have an effect of acidifying the soil. Acidification of the soil is an effective means for citrus plants to resist HLB pathogen, and from this point of view, Fe²⁺ ions are also believed to be effective. The soil pH as of January 2021 were within the optimum range (5.8 to 6.5) in both Fe²⁺ ions-applied plot and the untreated plot.

4) Fruit Yield

| | Average yield | Box | Estimated number | Fruit drop |
|---|---|---|---|---|
| Hamlin | (pounds) | average | of fruit | rate (%) |
| Fe²⁺ plot | 292.7 | 3.3 | 887.0 | 23.1 |
| Untreated plot | 250.6 | 2.8 | 759.4 | 33.6 |

The table above shows data on fruit yield during the first year after the start of Fe²⁺ ions application. The drop rate of fruits decreased and the average yield increased in the Fe²⁺ ions-applied plot, as compared with those in the untreated plot. The drop rate of the fruit in the Fe²⁺ ions-applied plot was 10% or more lower than that in the untreated plot, and the average yield in the Fe²⁺ ions-applied plot was about 17% higher than that in the untreated plot. The harvest time of Hamlin orange was from late December to January. In only about half a year from the start of the Fe²⁺ ions application, good signs of fruit yield appeared.

| At harvest (after fruit drop) | | | | |
|---|---|---|---|---|
| | | Fruit | Before fruit drop | |
| Average | Estimated | drop | Average | Estimated |
| yield | number of | rate | yield | number of |
| (pounds)) | tree fruit | (%) | (pounds) | tree fruit |

Hamlin

| | | | | | |
|---|---|---|---|---|---|
| Fe²⁺ plot | 259.6 | 718 | 31.9 | 369.8 | 1054 |
| Untreated plot | 244.6 | 725 | 24.9 | 323.6 | 949 |

Valencia

| | | | | | |
|---|---|---|---|---|---|
| Fe²⁺ plot | 294.60 | 659 | 8.87 | 338.16 | 723 |
| Untreated plot | 233.96 | 527 | 9.69 | 273.30 | 582 |

The table above shows data on fruit yield during the second year after the start of Fe²⁺ ions application. In the second year, no significant differences were observed in fruit yield, estimated number of fruits on tree and fruit drop rate at harvest between the Fe²⁺ ions-applied plot and the untreated plot in both Hamlin orange and Valencian orange due to the occurrence of brown rot disease. However, before the occurrence of brown rot disease (before fruit drop), the average yield of Valencian orange was significantly higher in the Fe²⁺ ions-applied plot than in the untreated plot. The number of fruits was also increased compared to the first year. This may be due to the continued application of Fe²⁺ ions and that the Fe²⁺ ions were applied five times in the second year whereas the Fe²⁺ ions were applied three times in the first year.

| | Size (mm) | Brix (%) | acidity (%) | Brix/acidity |
|---|---|---|---|---|
| Hamlin | | | | |
| Fe²⁺ plot | 66.3 | 9.79 | 0.61 | 16.06 |
| Untreated plot | 66.1 | 9.83 | 0.62 | 15.95 |
| Valencia | | | | |
| Fe²⁺ plot | 71.3 | 9.95 | 0.82 | 12.24 |
| Untreated plot | 71.3 | 9.69 | 0.78 | 12.55 |

The table above shows data on the quality of the fruit harvested in the second year. No significant difference was observed in the quality and size between in the Fe²⁺ ions-applied plot and in the untreated plot in both Hamlin orange and Valencian orange.

% Change from June 2019 to January 2020

| Valencia | N | F | K | Mg | Ca | S |
|---|---|---|---|---|---|---|
| Fe²⁺ plot | −13.78 | 24.32 | 41.47 | −15.24 | −15.33 | −13.67 |
| Untreated plot | −12.80 | 28.97 | 43.09 | −16.81 | −23.45 | −22.81 |
| | B | Zn | Mn | Fe | Cu | |
| Fe²⁺ plot | −33.04 | −70.19 | −74.23 | −8.55 | −44.42 | |
| Untreated plot | −41.03 | −76.24 | −79.35 | −18.96 | −55.55 | |
| Hamlin | N | P | K | Mg | Ca | S |
| Fe²⁺ plot | −12.44 | 26.49 | −20.46 | −13,11 | −25,39 | −19.24 |
| Untreated plot | −18.38 | 24.84 | −24.56 | −18.10 | −31.02 | −25.00 |
| | B | Zn | Mn | Fe | Cu | |
| Fe²⁺ plot | −38.85 | −74.36 | −80.27 | −30.52 | −89.57 | |
| Untreated plot | −46.92 | −73.58 | −79.03 | −30.81 | −90.68 | |

The table above shows the % change in the components contained in the tree leaves from June 2019 (summer) to January 2020 (winter). In Valencia orange, P and K increased and other components decreased in both plots. In Hamlin orange, only P increased and other components decreased in both plots. In Valencia orange, the degree of decrease in Ca, S, B, Fe, and Cu in the Fe²⁺ ions-applied plot was smaller than that in the untreated plot. In particular, the degree of reduction of Fe in the Fe²⁺ ions-applied plot was less than half of that in the untreated plot.

% change from January 2020 to June 2020

| Valencia | N | P | K | Mg | Ca | S |
|---|---|---|---|---|---|---|
| Fe²⁺ plot | 11.01 | −23.91 | −31.89 | 6.62 | 2.64 | −1.44 |
| Untreated plot | 13.90 | −25.13 | −36.60 | 8.22 | 15.43 | 15.38 |
| | B | Zn | Mn | Fe | Cu | |
| Fe²⁺ plot | 26.68 | 34.78 | 13.84 | 7.96 | −12.59 | |
| Untreated plot | 53.23 | 71.88 | 56.38 | 25.48 | 13.68 | |
| Hamlin | N | P | K | Mg | Ca | S |
| Fe²⁺ plot | 1.32 | −27.23 | 0.23 | 26.26 | 30.67 | 8.59 |
| Untreated plot | 7.48 | −26.53 | 7.72 | 18.78 | 31.11 | 17.28 |
| | B | Zn | Mn | Fe | Cu | |
| Fe²⁺ plot | 27.59 | 93.01 | 41.56 | 29.42 | −11.56 | |
| Untreated plot | 47.20 | 80.88 | 43.59 | 36.47 | −2.63 | |

The table above shows the % change in the components contained in the tree leaves from January 2020 (winter) to June 2020 (summer). In Valencia orange, the opposite phenomenon of change from summer to winter was observed. That is, P and K decreased, and the other components increased. In Valencia orange, the increase rates of Ca, S, B, Zn, Mn, Fe, and Cu in the Fe²⁺ ions-applied plot were smaller than those in the untreated plot. In particular, S and Cu were negative values and decreased from winter to summer. In Hamlin orange, the increase rates of N, K, S, and B in the Fe²⁺ ions-applied plot were smaller than those in the untreated plot.

% change from June 2019 to June 2020

| Valencia | N | P | K | Mg | Ca | S |
|---|---|---|---|---|---|---|
| Fe²⁺ plot | −4.29 | −5.41 | −3.65 | −9.63 | −13.10 | −14.91 |
| Untreated plot | −0.68 | −3.45 | −9.28 | −9.97 | −11.64 | −10.94 |
| | B | Zn | Mn | Fe | Cu | |
| Fe²⁺ plot | −15.17 | −59.82 | −70.66 | −1.40 | −51.42 | |
| Untreated plot | −9.65 | −59.17 | −67.71 | 1.69 | −49.47 | |
| Hamlin | N | P | K | Mg | Ca | S |
| Fe²⁺ plot | −11.29 | −7.95 | −20.28 | 9.71 | −2.50 | −12.30 |
| Untreated plot | −12.27 | −8.28 | −18.74 | −2.71 | −9.56 | −12.04 |
| | B | Zn | Mn | Fe | Cu | |
| Fe²⁺ plot | −21.98 | −50.50 | −72.06 | −10.07 | −90.78 | |
| Untreated plot | −21.87 | −52.21 | −69.86 | −5.57 | −90.93 | |

The table above shows the % change in the components contained in the tree leaves for one year from June 2019 (summer) to June 2020 (summer). In both Valencia orange and Hamlin orange, most components tended to decrease in the untreated plot. In Valencia orange, the decrease of B and Fe in the Fe²⁺ ions-applied plot was large. In Hamlin orange, Mg increased and Fe decreased in the Fe²⁺ ions-applied plot.

Interestingly, a difference in leaf nutrient migration was observed in trees in the Fe²⁺ ions-applied plots. HLB is a disease in which the migration of nutrients in trees is inhibited. Thus, the application of Fe²⁺ ions may have begun to normalize nutrient migration to resist HLB pathogen.

% change from June 2020 to June 2021

| Valencia | N | P | K | Mg | Ca | S |
|---|---|---|---|---|---|---|
| Fe²⁺ plot | 0.42 | 18.84 | −11.96 | 16.31 | 2.71 | 23.27 |
| Untreated plot | 2.08 | 19.15 | −6.70 | 13.90 | 3.68 | 18.31 |
| | B | Zn | Mn | Fe | Cu | |
| Fe²⁺ plot | −12.21 | 16.59 | 211.47 | −15.85 | −39.85 | |
| Untreated plot | −8.56 | 27.52 | 239.57 | −10.91 | −38.28 | |
| Hamlin | N | P | K | Mg | Ca | S |
| Fe²⁺ plot | −9.25 | 10.71 | −12.52 | −9.29 | −14.65 | 10.32 |
| Untreated plot | −7.84 | 14.62 | −10.86 | −4.65 | −18.09 | 8.90 |
| | B | Zn | Mn | Fe | Cu | |
| Fe²⁺ plot | 7.74 | 23.91 | 320.64 | −4.10 | −48.30 | |
| Untreated plot | −3.10 | 39.02 | 324.70 | 5.84 | 21.08 | |

The table above shows the % change in the components contained in the tree leaves from June 2020 (summer) to January 2021 (winter). In Valencian orange, no significant differences were observed in any of the plots. In Hamlin orange, the increase rate of B in the Fe²⁺ ions-applied plot was larger than that in the untreated plot, and a significant difference was observed. Leaves infected by HLB are considered to use more B.

However, the application of Fe²⁺ ions may result in the active uptake of B and the remarkable increase in B.

6) Quantification of Pathogen

| Ct value in qPCR | | |
|---|---|---|
| June 2019 | January 2020 | June 2020 |

Valencia

| | | | |
|---|---|---|---|
| Fe²⁺ plot | 28.79 | 26.16 | 29.57 |
| Untreated plot | 28.74 | 26.60 | 30.35 |

Hamlin

| | | | |
|---|---|---|---|
| Fe²⁺ plot | 27.01 | 25.90 | 28.36 |
| Untreated plot | 25.68 | 25.15 | 29.54 |

The table above shows the results of the semi-quantitative analysis (Ct values in real-time quantitative PCR) of Candidatus liberibacter asiaticus (cLas). As is clear from the table, no significant difference was observed in the amount of pathogen in any of the plots. Fe²⁺ ions may induce the expression of agene that alleviates the HLB symptoms rather than killing the pathogen. In addition, since the trees are cultivated in a real farm environment, Diaphorina citri sequentially attacks the trees, the infection of pathogen may repeat before HLB is cured.

7) Crown Volume and Crown Density

| Crown volume (m³) | | | | | |
|---|---|---|---|---|---|
| June | January | June | Difference (%) | | |
| 2019 | 2020 | 2020 | 0-6 mo. | 6-12 mo. | 0-12 mo. |

Valencia

| | | | | | | |
|---|---|---|---|---|---|---|
| Fe²⁺ plot | 30.27 | 32.14 | 33.65 | 5.88 | 4.70 | 11.17 |
| Untreated | 21.43 | 23.97 | 24.47 | 10.88 | 2.09 | 14.19 |
| plot | | | | | | |

Hamlin

| | | | | | | |
|---|---|---|---|---|---|---|
| Fe²⁺ plot | 34.24 | 38.99 | 35.13 | 12.23 | −9.90 | 2.59 |
| Untreated | 36.42 | 43.14 | 34.72 | 14.71 | −19.52 | −4.67 |
| plot | | | | | | |

The table above shows the crown volume (m³) of the trees in June 2019, January 2020 and June 2020 and the amount of change in each period. It must be noted that citrus trees have the property of stopping the growth of the root in the underground part when the crown in the above-ground part is growing, and the property of stopping the growth of the crown in the above-ground part when the root in the underground part is growing. In Valencia orange in the untreated plot, the root density decreased as described above, suggesting that carbohydrates were used for the growth of the above-ground part. In the Valencia orange in the Fe²⁺ ions-applied plot both roots and crowns grew. In Hamlin orange in the untreated plot, the root density increased as described above, while the crown volume decreased. In Hamlin orange in the Fe²⁺ ions-applied plot, both roots and crowns grew.

1% Change in crown volume from June 2020 to January 2021

| | Valencia | Hamlin |
|---|---|---|
| Fe²⁺ plot | −0.02 | 6.16 |
| Untreated plot | 8.74 | 7.50 |

The table above shows the % change in crown volume from June 2020 to January 2021. No significant difference in crown volume was observed in any of the plots.

| Crown density (% light blocking) | | |
|---|---|---|
| | | Change |
| June 2019 | June 2020 | amount (%) |

Valencia

| | | | |
|---|---|---|---|
| Fe²⁺ plot | 95.50 | 95.80 | 0.30 |
| Untreated plot | 95.30 | 95.90 | 0.60 |

Hamlin

| | | | |
|---|---|---|---|
| Fe²⁺ plot | 90.10 | 95.40 | 5.30 |
| Untreated plot | 89.80 | 95.50 | 5.70 |

The table above shows the crown density of the trees in June 2019 and June 2020 and the amount of change in one year. There was no significant difference in crown density in any of the plots.

1. A method for cultivating a citrus plant, comprising:
applying to the citrus plant a liquid composition comprising Fe ions, wherein at least a portion of the Fe ions are Fe²⁺ ions, wherein the citrus plant is cultivated in sandy soil.

2. The method of claim 1, wherein the citrus plant is Citrus sinensis, Citrus paradisi or Citrus limon.

3. The method of claim 1, wherein the citrus plant is infected with a pathogen of citrus greening disease.

4. The method of claim 1, wherein the citrus plant is cultivated in an environment where Diaphorina citri inhabits.

5. The method of claim 1, wherein the citrus plant is infected with a pathogen of brown rot disease.

6. The method of claim 1, wherein the concentration of total Fe ions in the liquid composition is from 100 mg/L to 1000 mg/L.

7. The method of claim 1, wherein at least 18% by weight of the total Fe ions of the liquid composition are Fe²⁺ ions.

8. The method of claim 1, wherein the liquid composition is applied by an irrigation tube.

9. The method of claim 1, wherein the liquid composition is applied 2 to 8 times per year.

10. The method of claim 1, wherein the liquid composition is applied from 0.27 g to 1.1 g of Fe²⁺ ions per citrus tree in a year.
